(19) United States
(12) Patent Application Publication
(10) Pub. No.: US 2024/0389575 A1
(43) Pub. Date: Nov. 28, 2024

(54) INTERCONNECTION DEVICE OF A LADDER ARRANGEMENT FOR AN ELEVATED HUNTING PLATFORM

(71) Applicant: American Pride Outdoors, LLC, Mt. Vernon, OH (US)

(72) Inventors: Thad J. Eads, Urbana, IN (US); Russell Waldon, Wabash, IN (US)

(73) Assignee: American Pride Outdoors, LLC, Mt. Vernon, OH (US)

(21) Appl. No.: 18/435,242

(22) Filed: Feb. 7, 2024

Related U.S. Application Data
(60) Provisional application No. 63/504,605, filed on May 26, 2023.

(51) Int. Cl. A01M 31/02; E06C 1/10

(52) U.S. Cl. CPC A01M 31/02; E06C 1/10

(57) ABSTRACT

A ladder arrangement for an elevated hunting platform arrangement of an elevated hunting platform system includes: a plurality of vertical ladder segments including a first vertical ladder segment and a second vertical ladder segment; and an interconnection device joining the first vertical ladder segment and the second vertical ladder segment together.

### CROSS REFERENCE TO RELATED APPLICATIONS

This is a non-provisional application based upon U.S. provisional patent application Ser. No. 63/504,605, entitled “AN INTERCONNECTION DEVICE OF A LADDER ARRANGEMENT FOR AN ELEVATED HUNTING PLATFORM”, filed May 26, 2023, which is incorporated herein by reference.

### BACKGROUND OF THE INVENTION

### 1. Field of the Invention

The present invention relates to treestand hunting systems, and, more particularly, to ladder arrangements for treestand hunting systems.

### 2. Description of the Related Art

Treestand hunting systems can include an elevated hunting platform such as a hang-on treestand. An exemplary such hang-on treestand is made by Novix Outdoors. As is known, the hang-on treestand mounts to the side of a tree, and the hunter can hunt therefrom. More specifically, the hang-on treestand can be attached to the trunk of a tree and includes a standing platform and optionally a seat. Once occupying the treestand and thus being elevated off of the ground, a hunter can selectively sit in the seat or stand on the standing platform, in order to conduct the hunt.

Further, the treestand hunting system can further include a ladder arrangement. According to one embodiment of the ladder arrangement, the ladder arrangement is in the form of one or more climbing sticks. According to another embodiment of the ladder arrangement, the ladder arrangement is in the form of a ladder attached to the hang-on treestand. A problem with these ladder arrangements is the inability to increase the overall length of these ladder arrangements connectively, readily, and quietly.

What is needed in the art is a ladder arrangement for an elevated hunting platform arrangement, the ladder arrangement being capable of being increased in overall length connectively, readily, and quietly.

### SUMMARY OF THE INVENTION

The present invention provides a ladder arrangement for an elevated hunting platform arrangement of an elevated hunting platform arrangement system, the ladder arrangement including an interconnection device.

The invention in one form is directed to a ladder arrangement for an elevated hunting platform arrangement of an elevated hunting platform system, the ladder arrangement including: a plurality of vertical ladder segments including a first vertical ladder segment and a second vertical ladder segment; and an interconnection device joining the first vertical ladder segment and the second vertical ladder segment together.

The invention in another form is directed to a method of using a ladder arrangement for an elevated hunting platform arrangement of an elevated hunting platform system, the method including the steps of: providing a plurality of vertical ladder segments including a first vertical ladder segment and a second vertical ladder segment; and joining the first vertical ladder segment and the second vertical ladder segment together by way of an interconnection device.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 illustrates a perspective and partially schematic view of an elevated hunting platform system, which includes an elevated hunting platform arrangement and a ladder arrangement, in accordance with an exemplary embodiment of the present invention;

FIG. 2 illustrates a perspective view of the ladder arrangement of FIG. 1, in accordance with an exemplary embodiment of the present invention;

FIG. 3 illustrates an exploded, perspective view of the ladder arrangement of FIG. 2 with portions broken away, the ladder arrangement including an interconnection device, in accordance with an exemplary embodiment of the present invention;

FIG. 4 illustrates a front perspective view of the interconnection device of FIG. 3, in accordance with an exemplary embodiment of the present invention;

FIG. 5 illustrates a rear perspective view of the interconnection device of FIG. 3, in accordance with an exemplary embodiment of the present invention;

FIG. 6 illustrates a cross-sectional view of the interconnection device of FIG. 3, taken along line 6-6 in FIG. 4, in accordance with an exemplary embodiment of the present invention;

FIG. 7 illustrates a perspective view of another embodiment of an elevated hunting platform system, which includes an elevated hunting platform arrangement and a ladder arrangement, with portions broken away, in accordance with an exemplary embodiment of the present invention;

FIG. 8 illustrates a perspective view of a single leg of the ladder arrangement of FIG. 7, which includes an interconnection device, in accordance with an exemplary embodiment of the present invention;

FIG. 9 illustrates a front perspective view of the interconnection device of FIG. 8, in accordance with an exemplary embodiment of the present invention;

FIG. 10 illustrates a rear perspective view of the interconnection device of FIG. 8, in accordance with an exemplary embodiment of the present invention;

FIG. 11 illustrates a cross-sectional view of the interconnection device of FIG. 8, taken along line 11-11 in FIG. 9, in accordance with an exemplary embodiment of the present invention; and

FIG. 12 illustrates a flow diagram showing a method of using a ladder arrangement for an elevated hunting platform arrangement of an elevated hunting platform system, in accordance with an exemplary embodiment of the present invention.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

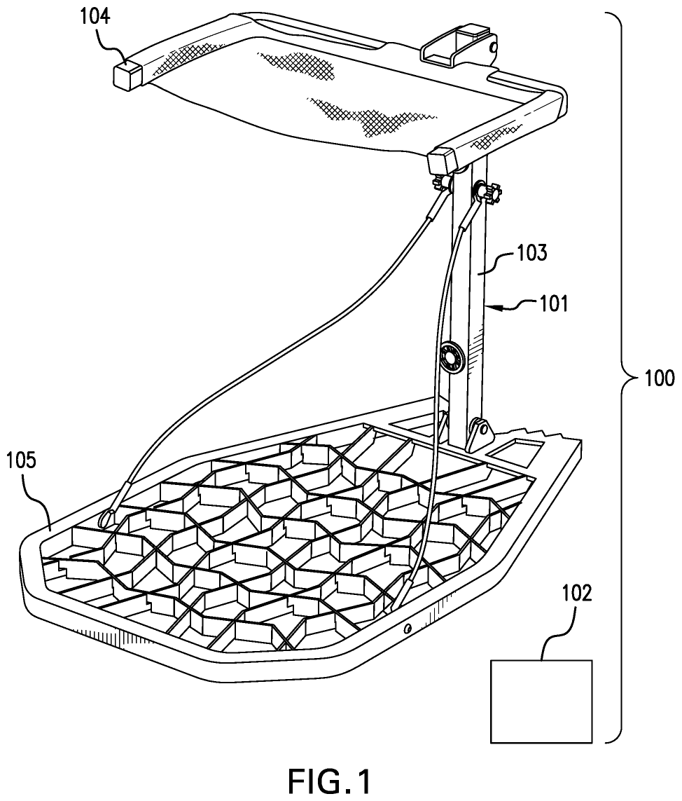

Referring now to the drawings, and more particularly to FIG. 1, there is shown an

elevated hunting platform system 100, shown schematically in part, according to one exemplary embodiment of system 100. System 100 generally includes an elevated hunting platform arrangement 101 and a ladder arrangement 102 (shown schematically in FIG. 1).

Elevated hunting platform arrangement 101, according to the embodiment shown in FIG. 1, is configured for being attached to a tree trunk and includes a support 103, a seat 104 coupled with support 103, and a platform 105 coupled with support 103. Seat 104 is configured for allowing a hunter to sit in seat 104. Platform 105 is configured for being a place where the hunter can place the hunter's feet while sitting in seat 104 or while standing on platform 105. Ladder arrangement 102 is configured for enabling the hunter to elevate from the ground to, for instance, elevated hunting platform arrangement 101. In this embodiment, ladder arrangement 102 is formed as a climbing stick arrangement 102 (which can also be referred to as a stick ladder or a single-leg ladder), which is not necessarily connected to elevated hunting platform arrangement 101. Climbing stick arrangement 102 may or may not be directly mechanically connected to elevated hunting platform arrangement 101; however, when arrangements 101, 102 are not directly mechanically connected with one another, it can be said that arrangements 101, 102 are indirectly connected with one another by way of the tree trunk to which both are attached.

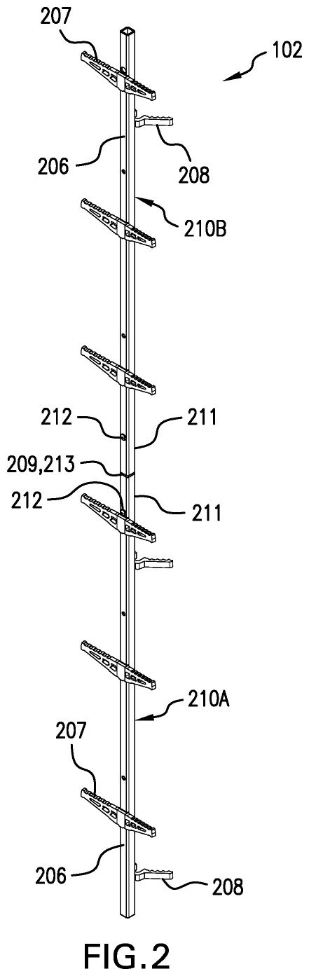

Referring now to FIG. 2, there is shown a perspective view of ladder arrangement 102, which includes a plurality of vertical ladder segments 210A, 210B and an interconnection device 209 which joins segments 210A, 210 together. Ladder segments 210A, 210B includes a first vertical ladder segment 210A and a second vertical ladder segment 210B. Stated another way, climbing stick arrangement 102 includes climbing sticks 210A, 210B including first climbing stick 210A and second climbing stick 210B positioned above first climbing stick 210A. Each climbing stick 210A, 210B includes a spine 206, one or more rungs 207 attached to spine 206, and one or more tree supports 208 attached to spine 206, wherein rungs 207 are configured for being that which the hunter steps on as the hunter climbs climbing stick arrangement 102, and tree supports 208 are configured for engaging with a tree trunk. Spine 206, rungs 207, and tree supports 208 of climbing sticks 210A, 210B can be made of any suitable material, such as a metal, such as aluminum or steel. Ladder segment 210A (more specifically, spine 206 of ladder segment 210A) includes longitudinal end 211, and ladder segment 210B (more specifically, spine 206 of ladder segment 210B) includes longitudinal end 211. Further, interconnection device 209 is only partially visible in FIG. 1 because interconnection device 209 is largely (that is, substantially) positioned within longitudinal ends 211 of climbing sticks 210A, 210B in FIG. 2. Interconnection device 209 includes two knobs 212 (which can also be referred to as protrusions 212) and a centrally located belt 213. Knobs 212 attach interconnection device 209 to climbing sticks 210A, 210B. Belt 213 is positioned between longitudinal ends 211 of climbing sticks 210A, 210B.

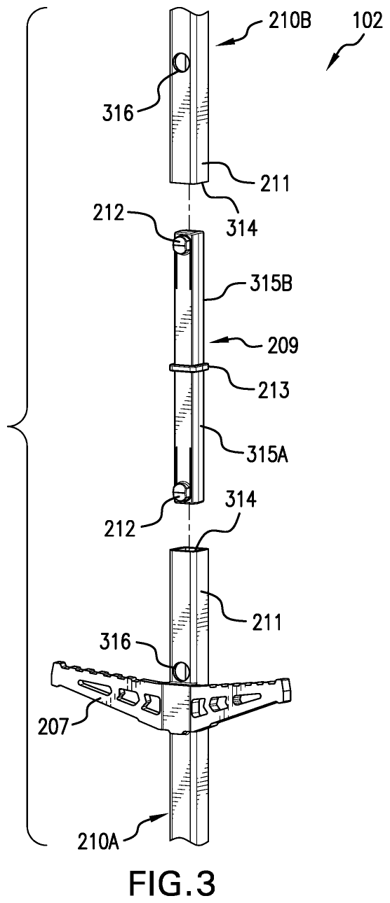

Referring now to FIG. 3, there is shown an exploded, perspective view of climbing stick arrangement 102, with portions broken away. More specifically, longitudinal ends 211 of climbing sticks 210A, 210B are shown exploded from interconnection device 209. Climbing sticks 210A, 210B (at least at their longitudinal ends 211) have an interior bore 314 which substantially matches an outer contour of lower and upper body portions 315A, 315B of interconnection device 209. Longitudinal ends 211 of climbing sticks 21A, 210 also include (more specifically, define) holes 316 that communicate with interior bores 314. During installation, body portions 315A, 315B are respectively inserted into each bore 314 of longitudinal ends 211 of climbing sticks 210A as knobs 212 are depressed downwards towards an interior of interconnection device 209, 210B, and knobs 212 pop back out at holes 316 and thus seat within holes 316. Interconnection device 209 is positioned substantially within longitudinal ends 211 in the sense that the portions interconnection device 209 not within interior bore 314 include belt 213 and portions of knobs 212.

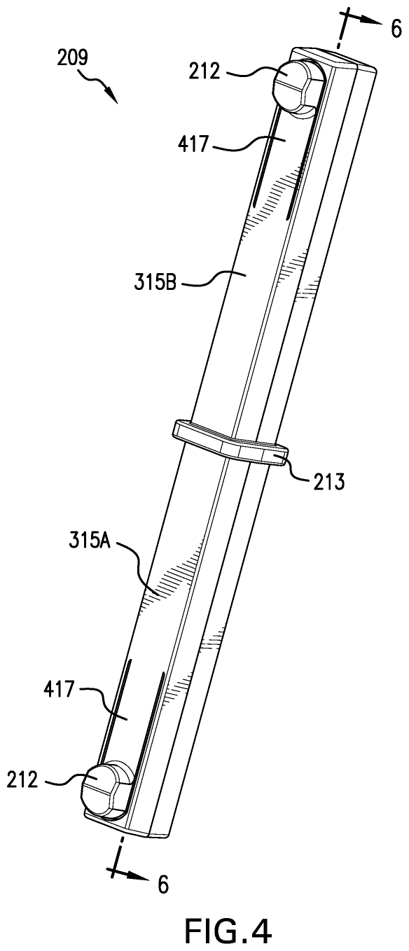

Referring now to FIG. 4, there is shown a front perspective view of interconnection device 209. Interconnection device 209 includes body portions 315A, 315B, belt 213, and knobs 212. Belt 213 is positioned substantially at a longitudinal midpoint of interconnection device 209 so as to substantially divide interconnection device 209 into lower and upper halves which include respectively lower and upper body portions 315A, 315B and a respective knob 212 (which can also be referred to as a button 212). Further, formed in body portions 315A, 315B are depressible portions 417, each of which includes a respective knob 212, depressible portions 417 being formed by partial cutouts in body portions 315A, 315B. Depressible portions 417 each form a cantilever and function as springs. Interconnection device 209 can have any suitable cross-sectional shape and dimensions; for instance, interconnection device 209 can have a generally square cross-section, as indicated in FIG. 4.

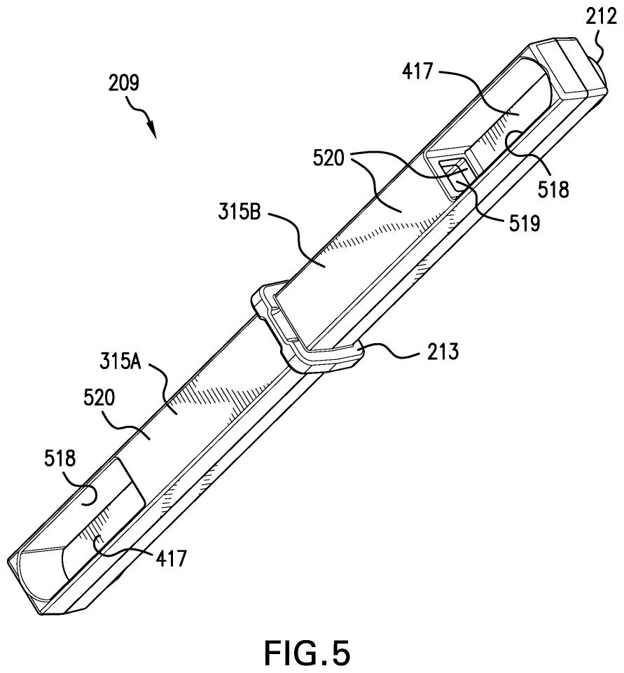

Referring now to FIG. 5, there is shown a rear perspective view of interconnection device 209. Interconnection device 209 includes body portions 315A, 315B, belt 213, and knobs 212. Belt 213 is positioned between lower body portion 315A and upper body portion 315B, longitudinal end 211 of first vertical ladder segment 210A abutting belt 213, and longitudinal end 211 of second vertical ladder segment 210B abutting belt 213. Interconnection device 209 further includes open spaces 518 behind depressible portions 417. Interconnection device 209 further includes an interior tube 519 and a plastic overmold 520 which is overmolded about interior tube 519. In this embodiment, interior tube 519 can have substantially a square cross-section and can be made of any suitable material, such as a durable material, such as a metal, such as aluminum or steel. Except for interior tube 519, all other parts of interconnection device 209 are overmold 520, including, for example, body portions 315A, 315B, depressible portions 417, knobs 212, and belt 213. Overmold 520 can be made of any suitable material; an exemplary material is Super Tough Nylon. Thus, advantageously, overmold 520 provides that there is no metal-to-metal contact when joining climbing sticks 210A, 210B together by interconnection device 209, which substantially eliminates noise when joining climbing sticks 210A, 210B together and when the hunter is climbing stick arrangement 102. Further, interconnection device 209 is easy to install in the field and eliminates any need for nuts, bolts, pins, etc. to effect the coupling of climbing sticks 210A, 210B together. Further, interconnection device 209 includes lower body portion 315A and upper body portion 315B coupled with lower body portion 315A, lower body portion including first depressible portion 417 including first protrusion 212, second body portion 315B including second depressible portion 417 including second protrusion 212, first protrusion 212 being configured for seating within first hole 316, and second protrusion 212 being configured for seating within second hole 316. When joining vertical ladder segment 210A and vertical ladder segment 210B together, body portion 315A is configured for sliding relative to longitudinal end 211 of vertical ladder segment 210A and body portion 315B is configured for sliding relative to longitudinal end 211 of vertical ladder segment 210B.

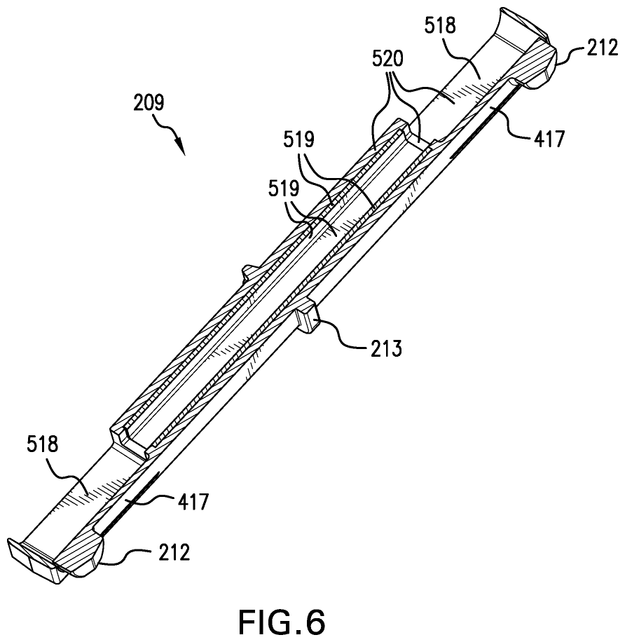

Referring now to FIG. 6, there is shown a cross-section of interconnection device 209 taken along line 6-6 in FIG. 4. Line 6-6 splits interconnection device 209 in half longitudinally. Interconnection device 209 includes body portions 315A, 315B, depressible portions 417, knobs 212, belt 213, open spaces 518, interior tube 519, and overmold 520. Because FIG. 6 is a cross-sectional view, only a longitudinally extending half of interior tube 519 is shown, but it can be appreciated that the other longitudinally extending half of interior tube 519 is substantially similar thereto.

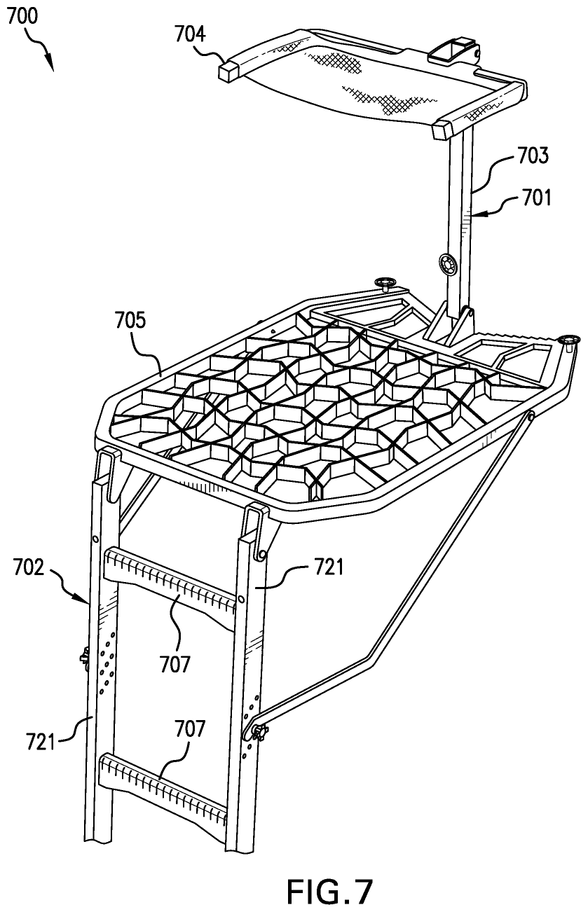

Referring now to FIG. 7, there is shown a perspective view of another embodiment of the elevated hunting platform system, namely, elevated hunting platform system 700, with portions broken away, according to an exemplary embodiment of the present invention. With respect to elevated hunting platform system 700, many prior reference numbers with respect to elevated hunting platform system 100 are increased by a multiple of 100 and thus are substantially similar to the structures and function described and shown with respect to system 100, unless otherwise shown and/or described differently. System 700 includes elevated hunting platform arrangement 701 and ladder arrangement 702 coupled with elevated hunting platform arrangement 701, as shown. Elevated hunting platform arrangement includes support 703, seat 704, and platform 705. The primary difference between system 100 and system 700 is with ladder arrangement 702. Ladder arrangement 702 (portions of which are broken away in FIG. 7) is not a stick ladder but instead includes a pair of parallel, vertical legs 721 and rungs 707 therebetween (ladder arrangement 702 can also be referred to as a two-leg ladder). Legs 721 and rungs 707 can be made of any suitable material, such as a metal, such as aluminum or steel. As shown in FIG. 7, arrangements 701, 702 are directly mechanically connected with one another.

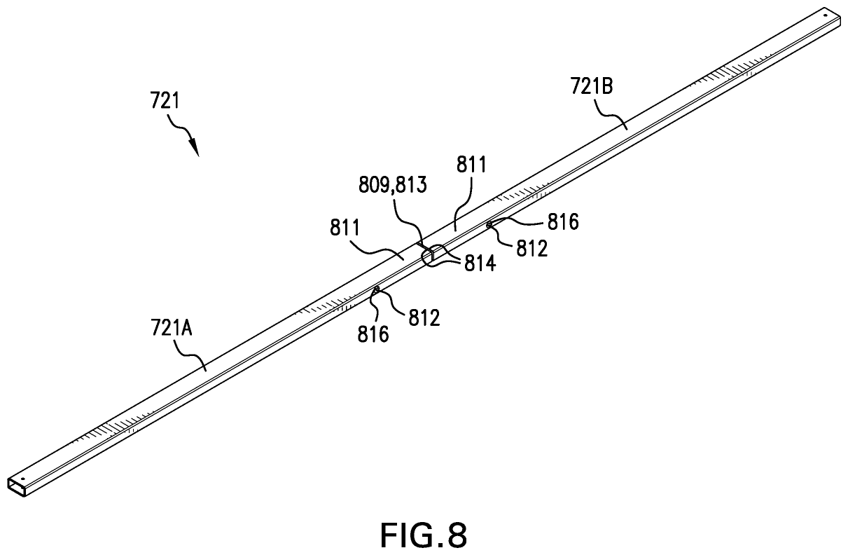

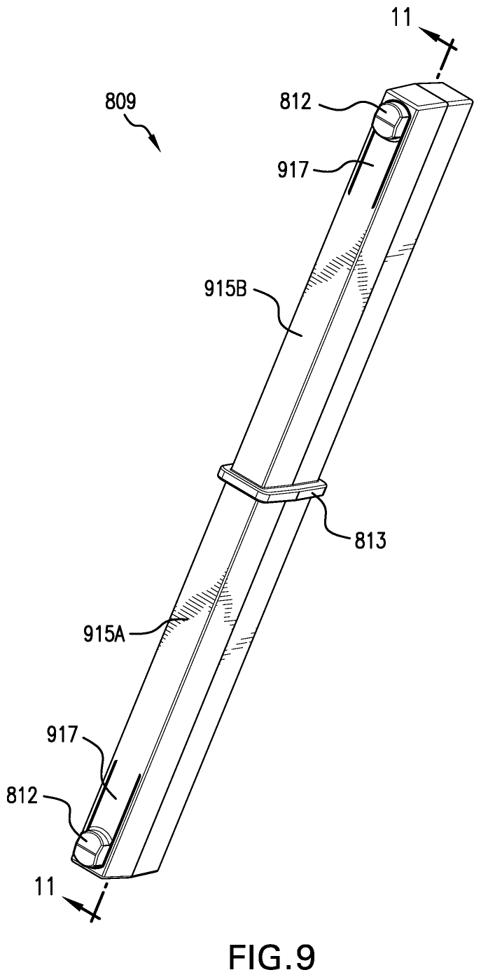

Referring to FIG. 8, there is shown a perspective view of a single leg 721 of ladder arrangement 702. Leg 721 includes lower leg segment 721A (which can also be referred to as vertical ladder segment 721A), upper leg segment 721B (which can also be referred to as vertical ladder segment 721B), and interconnection device 809 which joins lower and upper leg segments 721A, 721B together. Segment 721A includes longitudinal end 811, and segment 721B includes longitudinal end 811. Further, interconnection device 809 is only partially visible in FIG. 8 because interconnection device 809 is largely positioned within longitudinal ends 811 of leg segments 721 in FIG. 8. Interconnection device 809 includes two knobs 812 (which can also be referred to as protrusions 812) and a centrally located belt 813. Knobs 812 attach interconnection device 809 to leg segments 721A, 721B. Belt 813 is positioned between longitudinal ends 811 of leg segments 721A, 721B. The cross-sectional shape of legs 721, leg segments 721A, 721B, and interconnection device 809 is substantially rectangular. Longitudinal ends 811 each include (more specifically, define) a hole 816 which communicates with a respective interior bore 814 of longitudinal ends 811 of legs 721A, 721B and which receives knobs 812 respectively therein in order to lock leg segments 721A, 721B to interconnection device 809. Further, it can be appreciated that interconnection device 809 inserts in interior bore 814 of longitudinal ends 811 of legs 721A, 721B, interior bore 814 substantially matching an outer contour of lower and upper body portions 915A, 915B (FIG. 9) of interconnection device 809.

Referring now to FIG. 9, there is shown a front perspective view of interconnection device 809. Interconnection device 809 includes body portions 915A, 915B, belt 813, and knobs 812. Belt 813 is positioned between lower body portion 915A and upper body portion 915B, longitudinal end 811 of lower leg segment 721A abutting belt 813, and longitudinal end 811 of upper leg segment 721B abutting belt 813. Further, formed in body portions 915A, 915B are depressible portions 917, each of which includes a respective knob 812, depressible portions 917 being formed by partial cutouts in body portions 915A, 915B. Depressible portions 917 each form a cantilever and function as springs. Interconnection device 809 is positioned substantially within longitudinal ends 811 in the sense that the portions interconnection device 809 not within the interior bore of longitudinal ends 811 of legs 721A, 721B include belt 813 and portions of knobs 812.

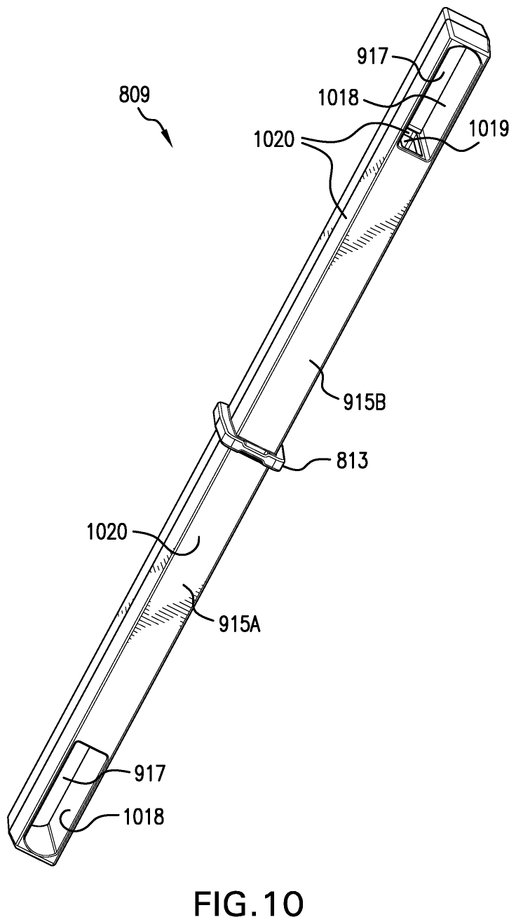

Referring now to FIG. 10, there is shown a rear perspective view of interconnection device 809. Interconnection device 809 further includes open spaces 1018, an interior tube 1019, and a plastic overmold 1020 which is overmolded about interior tube 1019. In this embodiment, interior tube 1019 can have substantially a rectangular cross-section and can be made of any suitable material, such as a durable material, such as a metal, such as aluminum or steel. Except for interior tube 1019, all other parts of interconnection device 809 are overmold 1020, including, for example, body portions 915A, 915B, depressible portions 917, knobs 812, and belt 813. Overmold 1020 can be made of any suitable material; an exemplary material is Super Tough Nylon. Further, interconnection device 809 includes lower body portion 915A and upper body portion 915B coupled with lower body portion 915A, lower body portion including first depressible portion 917 including first protrusion 812, second body portion 915B including second depressible portion 917 including second protrusion 812, first protrusion 812 being configured for seating within first hole 816, and second protrusion 812 being configured for seating within second hole 816. When joining vertical ladder segment 721A and vertical ladder segment 721B together, body portion 915A is configured for sliding relative to longitudinal end 811 of vertical ladder segment 721A and body portion 915B is configured for sliding relative to longitudinal end 811 of vertical ladder segment 721B.

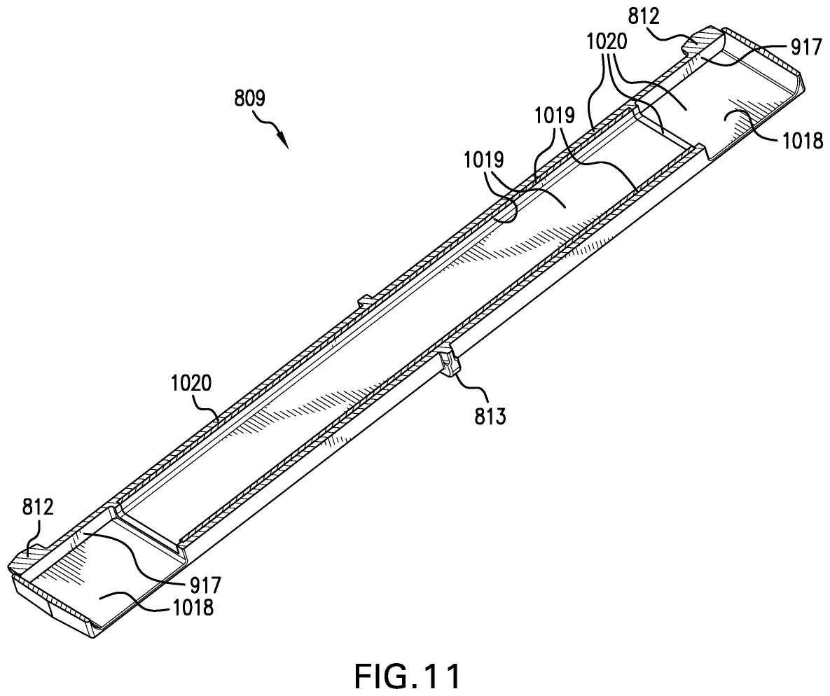

Referring now to FIG. 11, there is shown a cross-section of interconnection device 809 taken along line 11-11 in FIG. 9. Line 11-11 splits interconnection device 809 in half longitudinally. Interconnection device 809 is shown to include interior tube 1019 and overmold 1020. Because FIG. 11 is a cross-sectional view, only a longitudinally extending half of interior tube 1019 is shown, but it can be appreciated that the other longitudinally extending half of interior tube 1019 is substantially similar thereto.

Though the way of interconnecting (or, alternatively, what can be referred to as locking) the interconnection device and the ladder segments of the present invention is shown in the figures according to the embodiments of depressible portions 417, 917 and knobs 212, 812 of interconnection devices 209, 809 which insert in holes 316, 816 of ladder segments 210A, 210B, 721A, 721B to effect interconnection/locking (that is, knobs 212, 812 are depressible (a) to slide interconnection device 209, 809 into respective ladder segments 210A, 210B, 721A, 721B so that knobs 212, 812 insert into holes 316, 816 or (b) to release knobs 212, 812 from holes 316, 816 so as to slide interconnection device 209, 809 out of ladder segments 210, 210B, 721A, 721B), it can be appreciated that this is only one way according to the present invention by which to effect such interconnection (locking). Stated another way, the present invention is intended to cover a variety of ways of connecting the interconnection device (i.e., interconnection device 209, 809) to the ladder segments (i.e., ladder segments 210A, 210B, 721A, 721B), including but not limited to what is shown in the figures. For example (and not by way of limitation), in addition to what is shown in the figures, the way of interconnecting/locking the interconnection device and the ladder segments according to the present invention may employ a friction fit between the interconnection device and the ladder segments, without using knobs and holes; alternatively, the way of interconnecting/locking may employ a rotating collar that expands an inner link (the interconnection device of the present invention), similar to the operation of a trekking pole.

In use, for either longitudinal end of interconnection device 209, 809 to be inserted into the interior bore 314 of spine 206 of climbing sticks 210A, 210B or leg segments 721A, 721B, the hunter depresses knob 212, 812 and then slides the respective longitudinal end of interconnection device 209, 809 further into the respective longitudinal end 211, 811 end of the climbing stick 210A, 210B or leg segment 721A, 721B, until knob 212, 812 is positioned in a hole 316, 816. When knob 212, 812 is so positioned, then knob 212, 812 pops out and seats in hole 316, 816 to secure interconnection device 209, 809 to climbing stick 210A, 210B or leg segment 721A, 721B. The other longitudinal end of interconnection device 209, 809 can be installed in the same manner to climbing stick 210A, 210B or leg segment 721A, 721B. To uninstall, knobs 212, 812 can be depressed, and then interconnection device 209, 809 can be slid out from climbing sticks 210A, 210B or leg segments 721A, 721B.

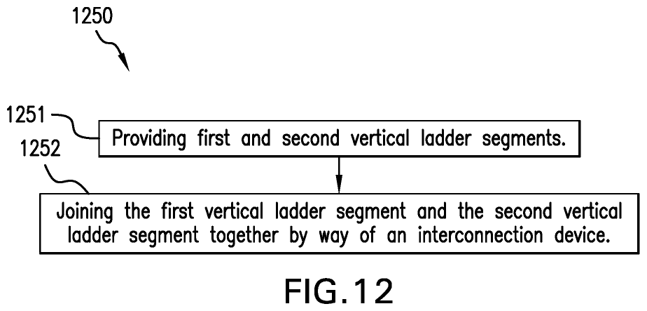

Referring now to FIG. 12, there is shown a flow diagram showing a method 1250 of using a ladder arrangement 102, 702 for an elevated hunting platform arrangement 101, 701 of an elevated hunting platform system 100, 700, the method 1250 including the steps of: providing 1251 a plurality of vertical ladder segments 210A, 210B, 721A, 721B including a first vertical ladder segment 21A, 721A and a second vertical ladder segment 210B, 721B; and joining 1252 first vertical ladder segment 210A, 721A and second vertical ladder segment 210B, 721B together by way of an interconnection device 209, 809. Optionally, first vertical ladder segment 210A, 721A includes a first longitudinal end 211, 811, second vertical ladder segment 210B, 721B including a second longitudinal end 211, 811, interconnection device 209, 809 being positioned substantially within first longitudinal end 211, 811 and second longitudinal end 211, 811. Optionally, first longitudinal end 211, 811 of first vertical ladder segment 210A, 721A defines a first hole 316, 816, second longitudinal end 211, 811 of second vertical ladder segment 210B, 721B defining a second hole 316, 816, interconnection device 209, 809 including a first body portion 315A, 915A and a second body portion 315B, 915B coupled with first body portion 315A, 915A, first body portion 315A, 915A including a first depressible portion 417, 917 including a first protrusion 212, 812, second body portion 315B, 915B including a second depressible portion 417, 917 including a second protrusion 212, 812, first protrusion 212, 812 being configured for seating within first hole 316, 816, and second protrusion 212, 812 being configured for seating within second hole 316, 816. Optionally, interconnection device 209, 809 includes an interior tube 519, 1019 and a plastic overmold 520, 1020 positioned about interior tube 519, 1019. Optionally, interconnection device 209, 809 includes a belt 213, 813 positioned between first body portion 315A, 915A and second body portion 315B, 915B, first longitudinal end 211, 811 of first vertical ladder segment 210A, 721A abutting belt 213, 813, and second longitudinal end 211, 811 of second vertical ladder segment 210B, 721B abutting belt 213, 813. Optionally, first depressible portion 417, 917 forms a first cantilever, and second depressible portion 417, 917 forms a second cantilever. When joining first vertical ladder segment 210A, 721A and second vertical ladder segment 210B, 721B together, first body portion 315A, 915A is configured for sliding relative to first longitudinal end 211, 811 of first vertical ladder segment 210A, 721A and second body portion 315B, 915B is configured for sliding relative to second longitudinal end 211, 811 of second vertical ladder segment 210B, 721B. Ladder arrangement 102 can be a stick ladder. Ladder arrangement 702 can be a two-leg ladder.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A ladder arrangement for an elevated hunting platform arrangement of an elevated hunting platform system, the ladder arrangement comprising:
a plurality of vertical ladder segments including a first vertical ladder segment and a second vertical ladder segment; and
an interconnection device joining the first vertical ladder segment and the second vertical ladder segment together.

2. The ladder arrangement according to claim 1, wherein the first vertical ladder segment includes a first longitudinal end, the second vertical ladder segment including a second longitudinal end, the interconnection device being positioned substantially within the first longitudinal end and the second longitudinal end.

3. The ladder arrangement according to claim 2, wherein the first longitudinal end of the first vertical ladder segment defines a first hole, the second longitudinal end of the second vertical ladder segment defining a second hole, the interconnection device including a first body portion and a second body portion coupled with the first body portion, the first body portion including a first depressible portion including a first protrusion, the second body portion including a second depressible portion including a second protrusion, the first protrusion being configured for seating within the first hole, and the second protrusion being configured for seating within the second hole.

4. The ladder arrangement according to claim 3, wherein the interconnection device includes an interior tube and a plastic overmold positioned about the interior tube.

5. The ladder arrangement according to claim 4, wherein the interconnection device includes a belt positioned between the first body portion and the second body portion, the first longitudinal end of the first vertical ladder segment abutting the belt, and the second longitudinal end of the second vertical ladder segment abutting the belt.

6. The ladder arrangement according to claim 5, wherein the first depressible portion forms a first cantilever, and the second depressible portion forms a second cantilever.

7. The ladder arrangement according to claim 6, wherein, when joining the first vertical ladder segment and the second vertical ladder segment together, the first body portion is configured for sliding relative to the first longitudinal end of the first vertical ladder segment and the second body portion is configured for sliding relative to the second longitudinal end of the second vertical ladder segment.

8. The ladder arrangement according to claim 1, wherein the ladder arrangement is a stick ladder or a two-leg ladder.

9. The ladder arrangement according to claim 1, wherein the ladder arrangement is a two-leg ladder.

10. A method of using a ladder arrangement for an elevated hunting platform arrangement of an elevated hunting platform system, the method comprising the steps of:
providing a plurality of vertical ladder segments including a first vertical ladder segment and a second vertical ladder segment; and
joining the first vertical ladder segment and the second vertical ladder segment together by way of an interconnection device.

11. The method according to claim 10, wherein the first vertical ladder segment includes a first longitudinal end, the second vertical ladder segment including a second longitudinal end, the interconnection device being positioned substantially within the first longitudinal end and the second longitudinal end.

12. The method according to claim 11, wherein the first longitudinal end of the first vertical ladder segment defines a first hole, the second longitudinal end of the second vertical ladder segment defining a second hole, the interconnection device including a first body portion and a second body portion coupled with the first body portion, the first body portion including a first depressible portion including a first protrusion, the second body portion including a second depressible portion including a second protrusion, the first protrusion being configured for seating within the first hole, and the second protrusion being configured for seating within the second hole.

13. The method according to claim 12, wherein the interconnection device includes an interior tube and a plastic overmold positioned about the interior tube.

14. The method according to claim 13, wherein the interconnection device includes a belt positioned between the first body portion and the second body portion, the first longitudinal end of the first vertical ladder segment abutting the belt, and the second longitudinal end of the second vertical ladder segment abutting the belt.

15. The method according to claim 14, wherein the first depressible portion forms a first cantilever, and the second depressible portion forms a second cantilever.

16. The method according to claim 15, wherein, when joining the first vertical ladder segment and the second vertical ladder segment together, the first body portion is configured for sliding relative to the first longitudinal end of the first vertical ladder segment and the second body portion is configured for sliding relative to the second longitudinal end of the second vertical ladder segment.

17. The method according to claim 10, wherein the ladder arrangement is a stick ladder.

18. The method according to claim 10, wherein the ladder arrangement is a two-leg ladder.
